(19) United States
(12) Patent Application Publication
(10) Pub. No.: US 2018/0080094 A1
(43) Pub. Date: Mar. 22, 2018

(54) MOUNTING ENCLOSURE WITH EXTERNALLY REMOVABLE INSERT PANEL

(71) Applicant: Process Technology International, LLC, Tucker, GA (US)

(72) Inventor: Martin Leber, Johns Creek, GA (US)

(21) Appl. No.: 15/269,425

(22) Filed: Sep. 19, 2016

(51) Int. Cl. C21C 5/52; H05B 7/18

(52) U.S. Cl. CPC C21C 5/5217; F27B 2014/0837; H05B 7/185

(57) ABSTRACT

The disclosed technology includes a mounting enclosure having a replaceable insert panel used to mount an apparatus used in a melting furnace. The replaceable insert panel may be accessed and removed from a rear open end of the mounting enclosure to allow replacement without having to access the interior of the furnace.

### TECHNICAL FIELD

Aspects of the present disclosure relate to an improved mounting enclosure having a replaceable insert panel used to mount an apparatus used in metal melting, refining, and processing, for example, steel making in an electric arc furnace (EAF), and more particularly, to an improved mounting enclosure having a replaceable insert panel that may be removed from the outside of the furnace.

### BACKGROUND

An electric arc furnace makes steel by using an electric arc to melt one or more charges of scrap metal that is placed within the furnace. The scrap is charged by dumping it into the furnace through the roof from buckets, which also may include charged carbon and slag forming materials. The arc melts the scrap into a molten pool of metal, called an iron carbon melt, which accumulates at the bottom or hearth of the furnace. After a flat bath has been formed by melting of all the scrap introduced, the electric arc furnace enters a refining or decarburizing phase. In this phase, the metal continues to be heated by the arc until the slag forming materials combine with impurities in the iron carbon melt and rise to the surface as slag. When the iron carbon melt reaches a boiling temperature, the charged carbon in the melt combines with any oxygen present in the bath to form carbon monoxide bubbles that rise to the surface of the bath. Generally, at this time supersonic flows of oxygen are blown at the bath with either lances or burners to produce a decarburization of the bath by the oxidation of the carbon contained in the bath. By simultaneously boiling the bath and injecting it with oxygen, the carbon content of the bath is reduced to under 2% carbon whereby the iron carbon melt becomes steel. The carbon in the steel bath is thereafter further reduced until the grade of steel desired is produced, down to less than 0.2% for low carbon steels.

An auxiliary oxy/fuel burner which is useful in the process of steel production in electric arc furnaces and which provides subsonic and supersonic flows of oxygen through the same centrally located conduit are manufactured and commercially sold by Process Technology International, Inc. of Tucker, Ga., the assignee of the present invention. The subsonic flow is produced by providing a pressure in the supply conduit lower than the critical pressure of the supersonic nozzle being used in the conduit. When supersonic oxygen is needed, the pressure in the supply conduit is increased to above the critical pressure.

Another burner with the capability to introduce supersonic or subsonic oxidizing gas into an electric arc furnace is illustrated in U.S. Pat. No. 6,342,086, entitled “Method and Apparatus for Improved EAF Steelmaking”, filed Feb. 15, 1999 in the name of V. Shver (herein, “Shver I”), and assigned commonly with the present application. Shver I discloses an annular nozzle for producing a supersonic oxygen flow surrounding a carbon injection conduit forming a portion of a nozzle in a fluid cooled combustion chamber of the burner.

Still another burner with the capability to introduce supersonic or subsonic oxidizing gas into an electric arc furnace is illustrated in U.S. Pat. No. 6,372,010 entitled “Improved Method and Apparatus For Metal Melting, Refining and Processing”, filed Dec. 10, 1999 in the names of V. Shver, et al. (herein, “Shver II”), and assigned commonly with the present application. Shver, II discloses a supersonic oxygen conduit in a side-by-side arrangement with a carbon injection conduit forming a portion of a nozzle in a fluid cooled combustion chamber of the burner.

Additionally, there are many other burners and lances which provide a supersonic oxidizing gas lancing capability and introduce different materials in the form of particles for use in the electric arc furnaces.

The supersonic lancing mode is used in one instance for melt refining because the flow of oxygen must penetrate the molten slag and produce a dimple in the molten metal to accelerate the refining process in the hearth of the furnace. The increased velocity of the gas from accelerating it to a supersonic condition increases its momentum and thus the depth of penetration into the melt. Another technique to increase the penetrating power of an oxidizing gas flow is to decrease the distance the supersonic oxygen must travel to reach the molten metal. The mounting of these burners and lances have generally been either through openings in the furnace, which are used for other purposes, such as the slag door, or the EBT access panels, or in greater numbers through specially made openings in the water-cooled panels of the sidewall of the furnace. The specially made sidewall openings allow the burners to be strategically mounted on the furnace wall, for example, where there are cold spots in the furnace, or other desired places, possibly for the introduction of process materials in the form of particles. To improve the penetrating power and efficiency of the supersonic oxidizing gas flows from the burners, the mountings of the burners in the furnace sidewall have been as far down on the sidewall panels as possible. However, there has been a limit to the mounting of the burners in proximity to the melt because of the structure of many present day furnaces.

The hearth of the furnace is made of refractory materials to contain the molten metal during steel processing. The hearth of the furnace forms a step with the water-cooled panels of the furnace sidewall where they connect. Thus, to deliver the oxygen flow at the optimum angle of about 50 degrees from horizon the burners and/or oxygen delivery apparatus should be installed higher to overpass the step. However, in this situation the distance that the oxygen must travel to attack the melt increases so much that such positioning of the oxygen delivery apparatus significantly increases the time of refining. This problem had been solved by moving the burners down close to the step and forwards to be in the vicinity of the edge of the step. However, in this new position, the oxygen delivery apparatus and the mounting enclosure that houses it are exposed to a very high heat flux, as well as aggressive splashing of molten slag and metal. Accordingly, providing a removable insert panel for the mounting enclosure may increase the operational lifespan of the mounting enclosure and minimize the need to perform maintenance. Improvements to mounting enclosures have been developed for burners and lances with supersonic oxidizing gas capability mounted closer to the molten metal and directed to the center of the furnace at about 50 degrees angle to the horizon so that they can be more efficient in operation. Such improved mounting enclosures also allow the burners and lances to operate at optimum flow rates, and at optimum distances from the melt. For example, such an improved mounting enclosure is illustrated in U.S. Pat. No. 6,289,035 entitled “Mounting Arrangement for Auxiliary Burner or Lance”, filed Feb. 10, 2000 in the name of V. Shver herein, “Shver III”), and assigned commonly with the present application. Another improved mounting enclosure is illustrated in U.S. Pat. No. 6,614,831 entitled “Mounting Arrangement for Auxiliary Burner or Lance”, filed Jul. 10, 2001 in the name of V. Shver (herein, “Shver IV”), and assigned commonly with the present application.

Mounting enclosures such as those of Shver III and IV may include a removable insert panel installed in the mounting block to support, position, and provide cooling to the burner. Because the insert panel is positioned such that it will generally be subjected to the most intense heat flux of the furnace and splashes of hot metal and the slag produced by the operation of electric arc, the insert panel may eventually wear out and require replacement. Currently, to replace the insert panel during the furnace operation, the melt shop personnel may be required to remove the complete mounting enclosure assembly from the furnace wall. Another option is to remove the insert panel through the interior of the hot furnace and install the new insert panel from the inside the furnace shell. However, replacement insert panel by accessing the interior of the hot furnace is both time consuming and costly. For example, it may require use of an overhead crane, additional safety provisions, and specially trained maintenance personnel to replace an insert panel from the interior of the furnace.

Therefore, there is a need to provide a mounting enclosure that provides a replaceable insert panel that may be accessed and replaced from the outside of the furnace.

### BRIEF DESCRIPTION OF THE FIGURES

Reference will now be made to the accompanying figures, which are not necessarily drawn to scale, and wherein:

FIG. 1A is a front view of a mounting enclosure having an inserted insert panel, in accordance with an example embodiment of the presently disclosed subject matter.

FIG. 1B is a front view of a mounting enclosure having an inserted insert panel and burner apparatus, in accordance with an example embodiment of the presently disclosed subject matter.

FIG. 1C is a front view of a mounting enclosure with an insert panel positioned for removal, in accordance with an example embodiment of the presently disclosed subject matter.

FIG. 2A is a perspective view of a mounting enclosure, insert panel and burner apparatus, in accordance with an example embodiment of the presently disclosed subject matter.

FIG. 2B is a top view of a mounting enclosure, insert panel and burner apparatus, in accordance with an example embodiment of the presently disclosed subject matter.

FIG. 2C is a cross-sectional side view of a mounting enclosure and insert panel, in accordance with an example embodiment of the presently disclosed subject matter.

FIG. 2D is a cross-sectional side view of the mounting enclosure of FIG. 2C wherein the insert panel has been inserted into the mounting enclosure, in accordance with an example embodiment of the presently disclosed subject matter.

FIG. 3 is an exploded perspective view of an insert panel, in accordance with an example embodiment of the presently disclosed subject matter.

FIG. 4A is rear perspective view of a mounting enclosure having a fully inserted insert panel, in accordance with an example embodiment of the presently disclosed subject matter.

FIG. 4B is rear perspective view of a mounting enclosure having an insert panel that has been rotated for removal, in accordance with an example embodiment of the presently disclosed subject matter.

FIG. 4C is rear perspective view of a mounting enclosure having a partially removed insert panel, in accordance with an example embodiment of the presently disclosed subject matter.

FIG. 5 is a flow diagram of a method, according to an example embodiment of the presently disclosed subject matter.

### DETAILED DESCRIPTION

The present disclosure can be understood more readily by reference to the following detailed description of example embodiments and the examples included herein. Before the example embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for the purpose of describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Also, in describing the example embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, example embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the invention, for example.

Embodiments of the disclosed technology include a mounting enclosure having a replaceable insert panel used to mount a burner. Because the insert panel is subjected to extreme heat, it may need to be replaced from time to time to ensure the continued proper operation of the burner. In various embodiments, the insert panel may be removed and/or inserted from the rear side of the mounting enclosure, allowing a user to replace the panel without having to access the inside of the furnace to allow for safer, faster, and more efficient replacement of the insert panel. In some embodiments, a top surface of the mounting enclosure may include a fin to protect the burner from being damaged by, for example, scrap metal dropped into the furnace.

Throughout this disclosure, certain embodiments are described in exemplary fashion in relation to a mounting enclosure having an insert panel for supporting a burner. However, embodiments of the disclosed technology are not so limited. In some embodiments, the disclosed technique may be effective in mounting other such devices, such as lances, supersonic lances, conduits for introducing gases or other materials into the furnace, and any other such apparatus as may be useful or necessary in an electric arc furnace.

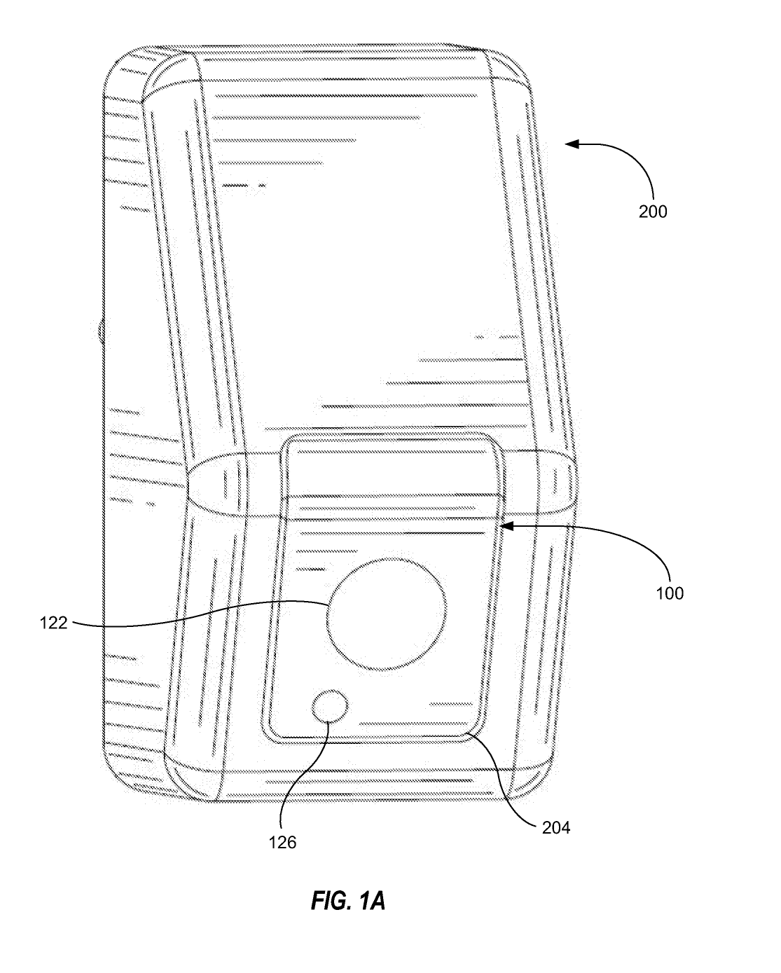

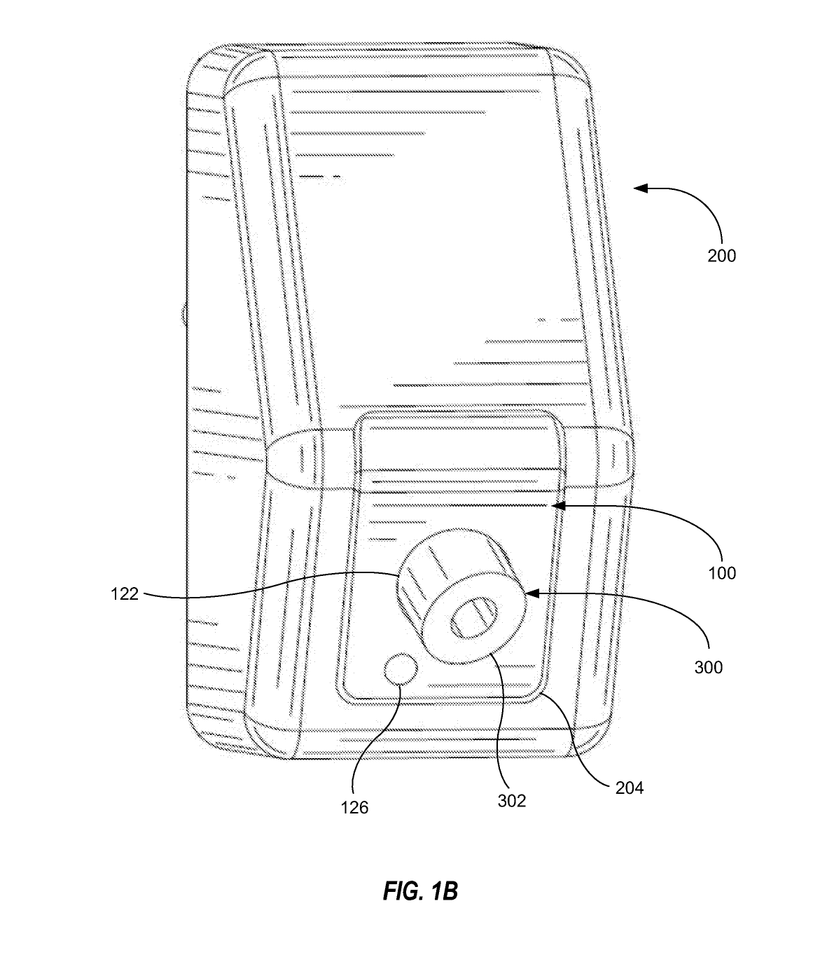

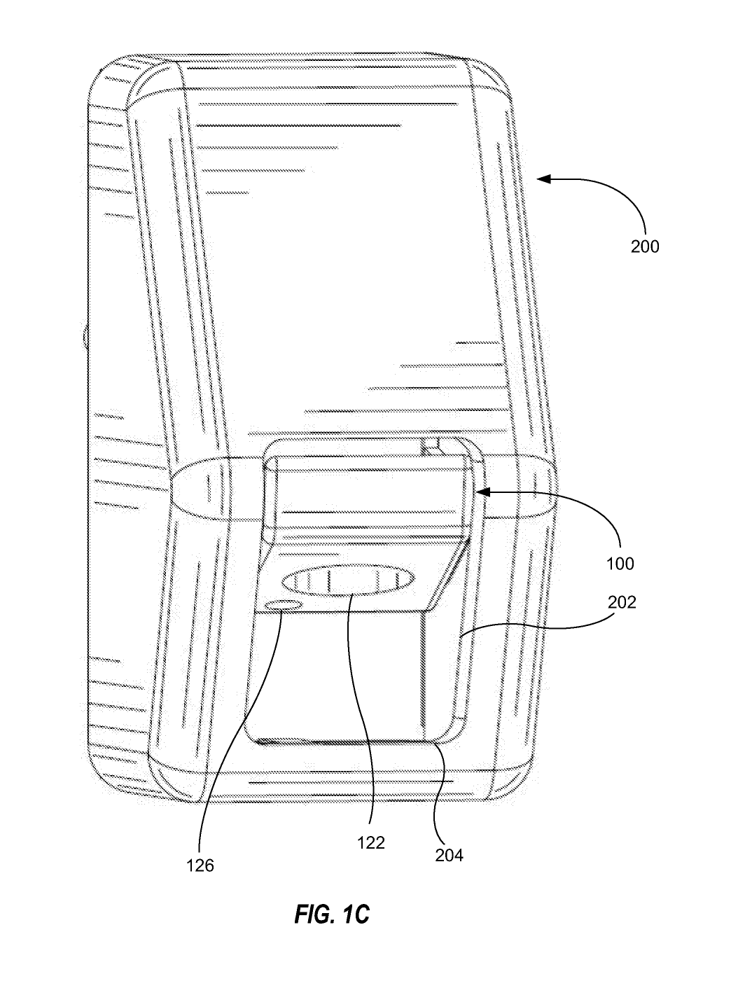

Referring now to the drawings, FIG. 1A illustrates an example embodiment of an assembled mounting enclosure device having an insert panel 100 fully inserted into a mounting enclosure 200. FIG. 1B illustrates an example embodiment of an assembled mounting enclosure device including insert panel 100 inserted into a mounting enclosure 200, and having a burner apparatus 300 inserted through a mounting enclosure of the insert panel 100. In some embodiments, the mounting enclosure 200 may be designed to removably receive the insert panel 100 and the insert panel 100 may be designed to removably receive the burner apparatus 300. When assembled and positioned for use in a furnace, this arrangement may provide the burner apparatus 300 with access to the inside of a furnace while the external surfaces of the insert panel 100 and mounting enclosure 200 provide shielding against the intense internal temperatures of the furnace. The insert panel 100 and mounting enclosure 200 may be made from water-cooled, or gas-cooled copper to provide shielding from the heat. FIG. 1C shows an example embodiment of a partially disassembled burner device, illustrating that the burner apparatus 300 has been removed and the removable insert panel 100 has been rotated in preparation for removal from the mounting enclosure 200.

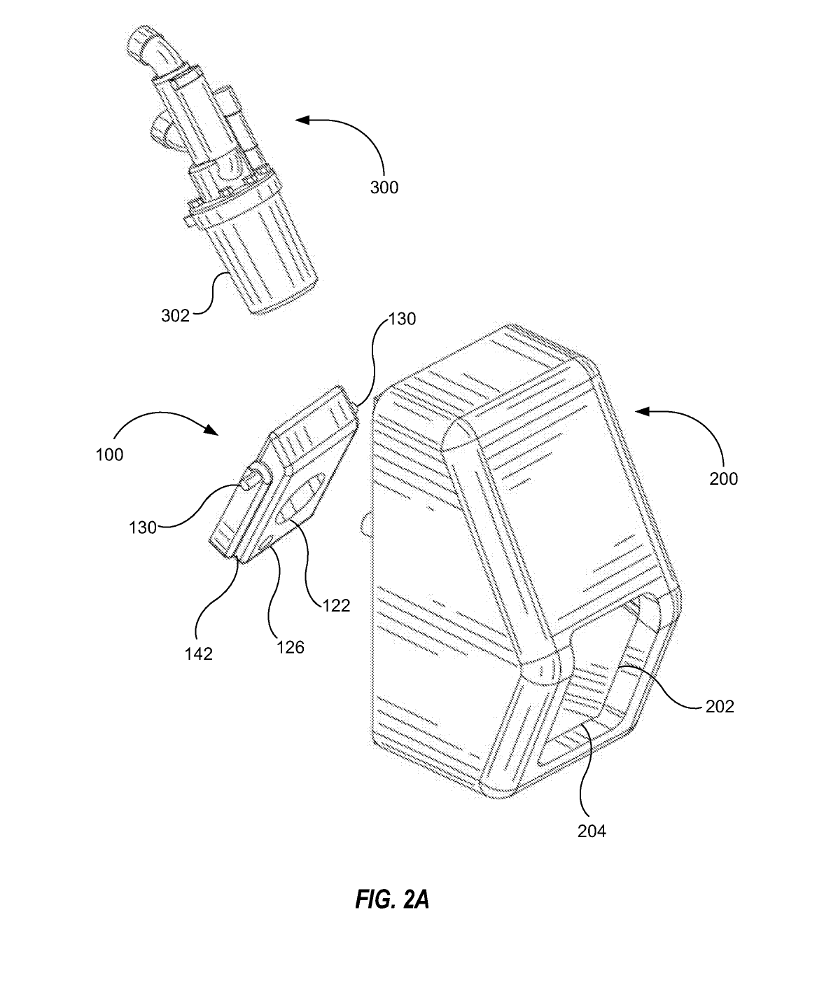

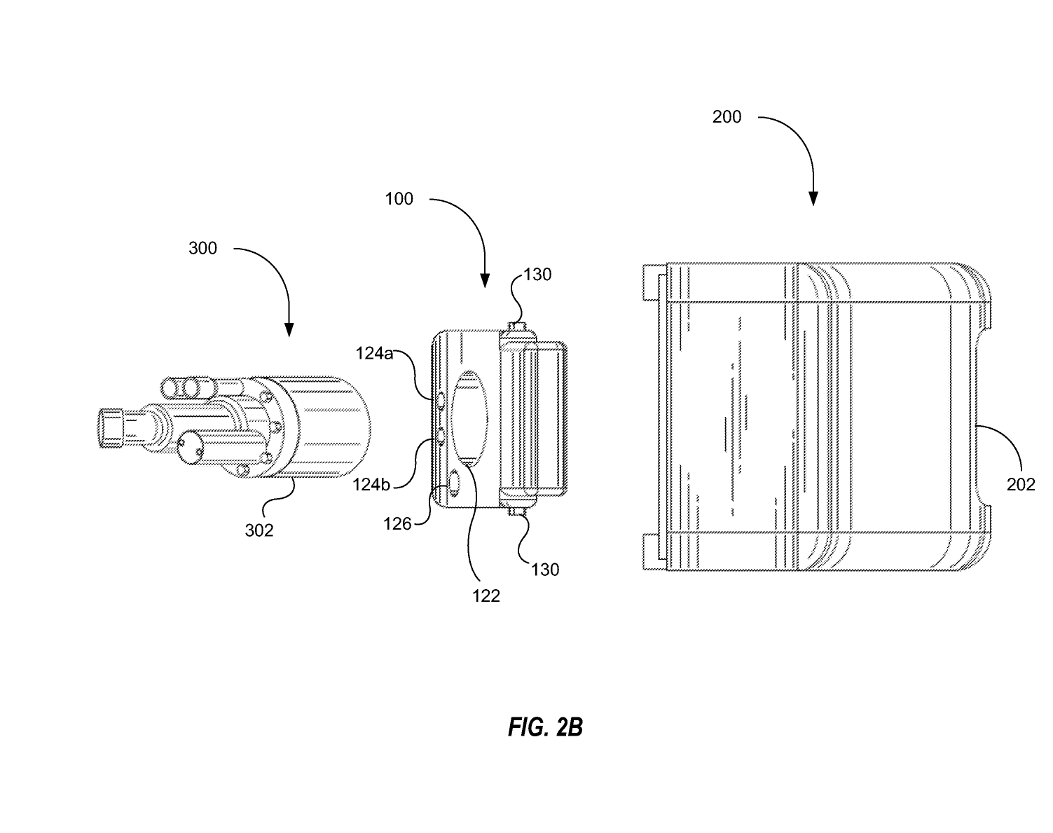

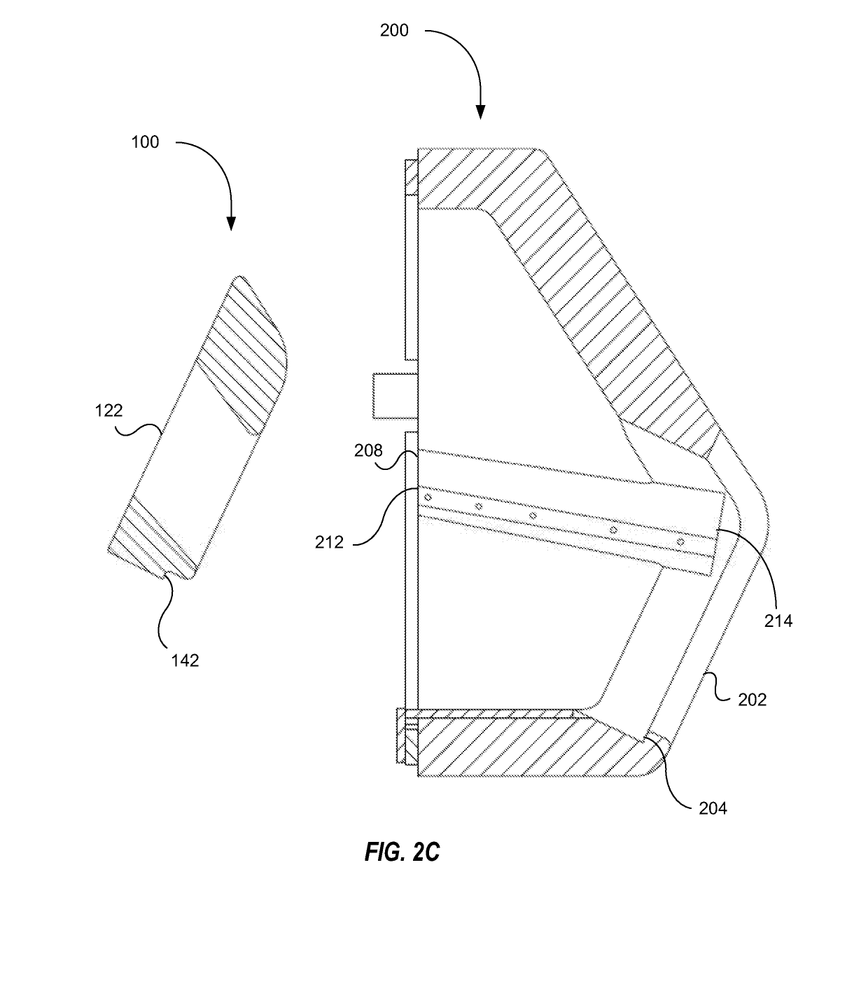

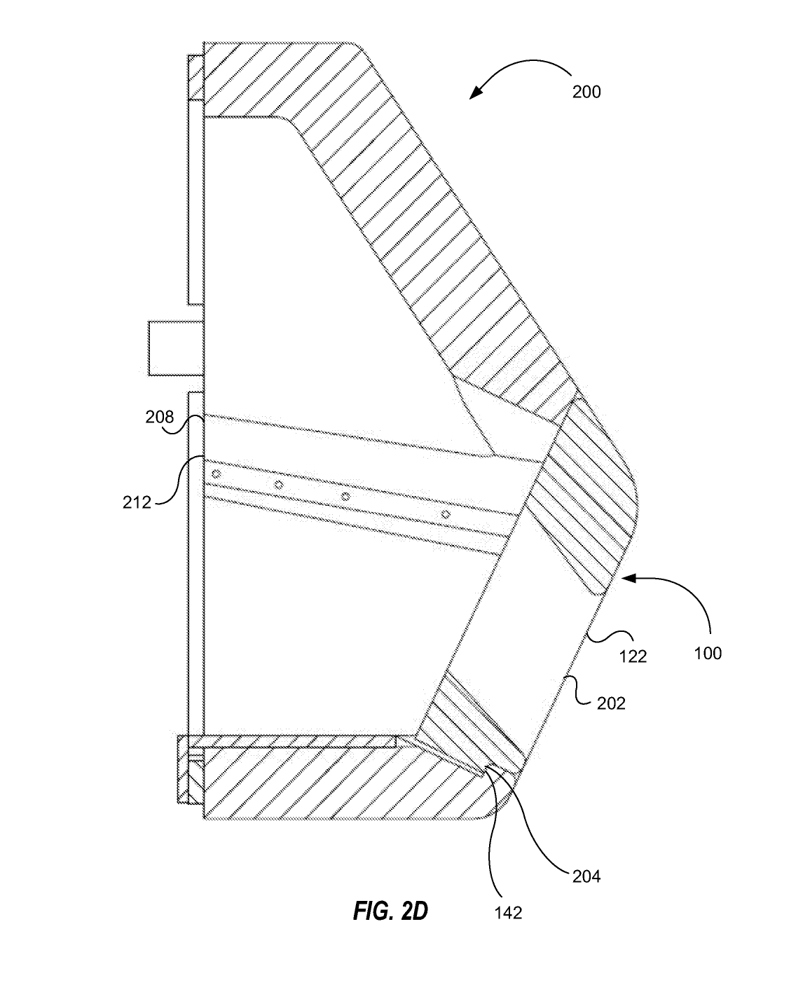

FIGS. 2A-2D illustrate various views of embodiments of a disassembled burner device separately showing the insert panel 100, mounting enclosure 200, and optionally showing burner apparatus 300. As shown in FIGS. 1A-2D, in some embodiments, the mounting enclosure 200 may include a top surface, a bottom surface, a first side surface, a second side surface and a front surface that form a substantially hollow enclosure. The mounting enclosure 200 may include an open face in the rear that may allow for insertion of the insert panel 100 and burner apparatus 300 into the mounting enclosure 200. In some embodiments, the front surface of the mounting enclosure 200 may include a sloped upper surface that extends downwards from the top surface and a sloped lower surface that extends upwards from the lower surface. In some embodiments, the sloped upper surface and sloped lower surface may intersect to form a generally convex profile of the mounting enclosure 200, as shown in FIG. 2A. The point of intersection of the sloped upper surface and the sloped lower surface may be referred to as the nose of the mounting enclosure 200. The front face of the mounting enclosure may include an aperture 202 for receiving the insert panel 100. In some embodiments, the aperture 202 may be a hole in the sloped lower surface. In some embodiments, the aperture 202 may be a hole that spans from the sloped lower surface to the sloped upper surface. According to some embodiments, the aperture 202 may have a rectangular shape when the mounting enclosure is viewed from the front. However, it should be understood that the aperture 202 might have different sizes and shapes in various embodiments, provided that size and shape of the aperture 202 is configured to receive the insert panel 100.

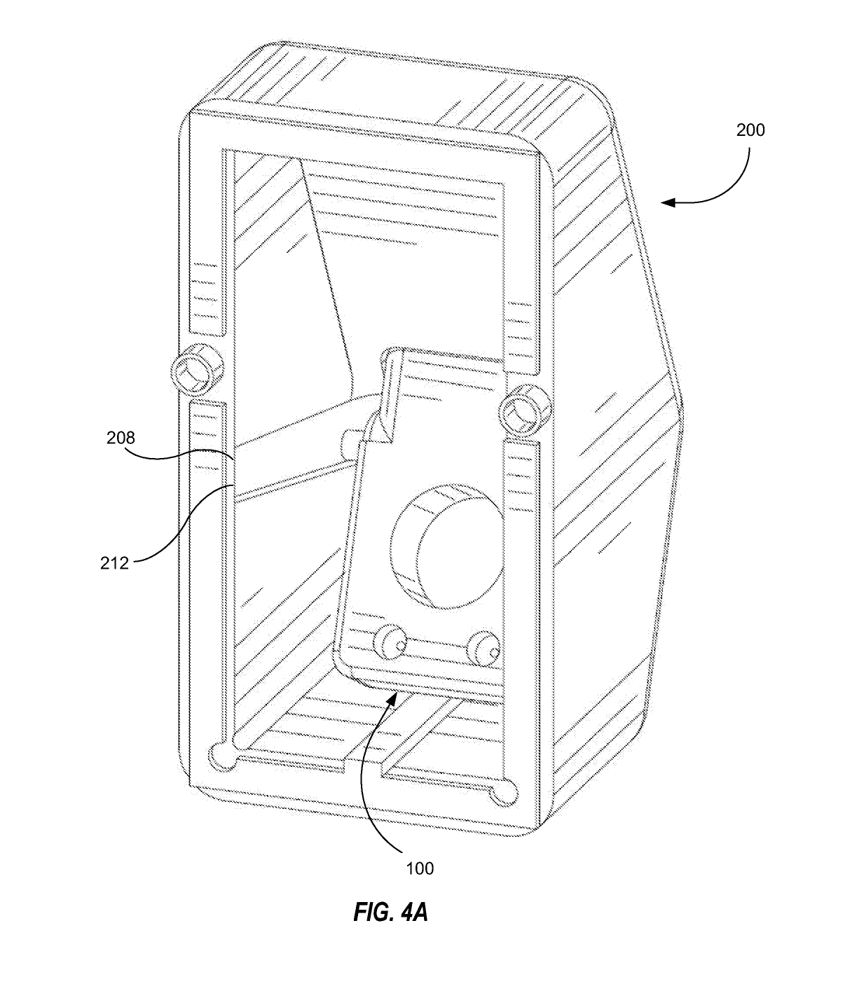

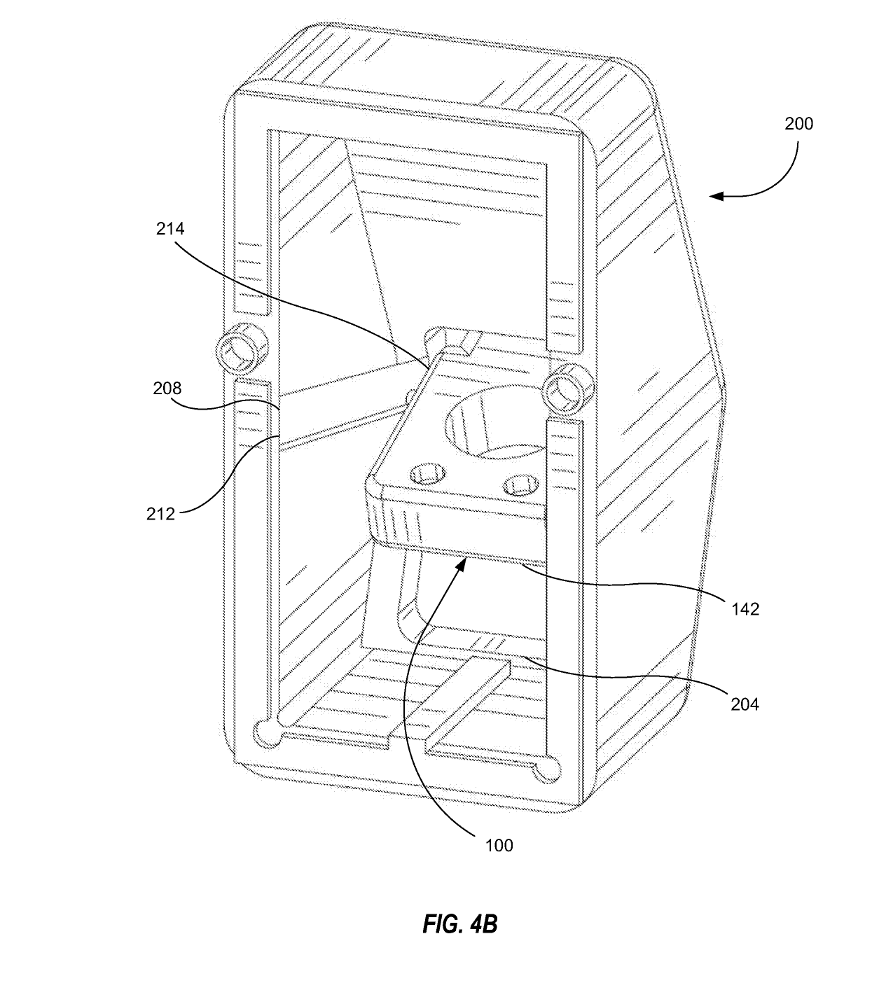

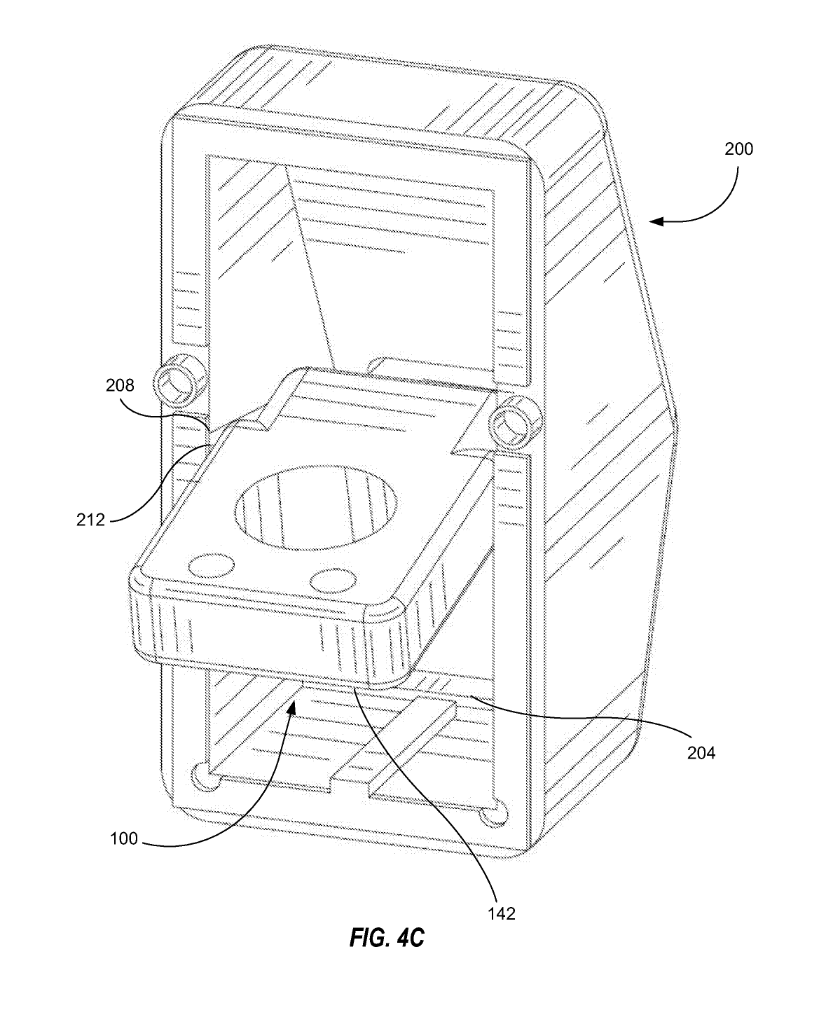

As shown in FIGS. 1A-2D, according to some embodiments, a removable insert panel 100 may be sized and shaped to substantially occupy the aperture 202 of the mounting enclosure 200 upon insertion. According to some embodiments, the insert panel 100 may be sized to substantially occupy the hole in the surface of the mounting enclosure 200 such that there are no gaps between the edge of the insert panel 100 and the edge of the gap of the mounting enclosure 200. For example, in some embodiments, the insert panel 100 may include a front surface, a rear surface, a first side surface, a second side surface, a top surface, and a bottom surface. According to some embodiments, the insert panel 100 may be generally rectangular when viewed from the front. In some embodiments, the top surface may have downward slope configured to conform with the sloped upper surface of the mounting enclosure 200 when the insert panel 100 is fully inserted into the mounting enclosure 200. In some embodiments, the front face of the insert panel 100 may be substantially flat such that it is configured to align with the orientation of the sloped lower surface of the mounting enclosure 200 when inserted. For example, as shown in FIG. 2D, according to some embodiments, an outer surface of an insert panel 100 that has been inserted into the mounting enclosure 200 such that it substantially occupies the aperture 202 may be aligned with the outer surface of the mounting enclosure 200 to create a continuous surface. According to some embodiments, the insert panel 100 may form a seal with the mounting enclosure 200 when inserted into aperture 202. In some embodiments, the insert panel 100 may be secured in position in the aperture 202 by a lip 142 of the bottom surface of the insert panel 100 engaging a lip 204 of a bottom surface of the mounting enclosure 200. In some embodiments, when substantially inserted into the aperture 202 of the mounting enclosure 200, an upper portion of the rear surface of the insert panel 100 may engage a portion of the top surface of the mounting enclosure 200. According to some embodiments, the lip 142 and upper portion of the rear surface of the insert panel 100 may engage the respective portions of the mounting enclosure 200 upon being rotated into position as described below with respect to FIGS. 4A-4C.

In some embodiments, the insert panel 100 may include one or more pole members (or posts) 130 for coupling with the interior of the mounting enclosure 200. One or more posts 130 may extend out of one or both side surfaces of the insert panel 100. According to some embodiments, a pole member 130 may include a roller. In some embodiments, the mounting enclosure 200 may include one or more internal grooves 208 for receiving the one or more posts 130 of the insert panel. For example, in some embodiments, the mounting enclosure may have an internal groove 208 on the inner face of each side surface, wherein each internal groove 208 comprises an indentation in the surface that is sized to receive a post 130, such as a roller, of the insert panel 100. Accordingly, in some embodiments, the insert panel 100 may be inserted into the open rear face of the mounting enclosure 200 by inserting the one or more posts 130 into the one or more internal grooves, respectively. In some embodiments, an internal groove 208 may be a shelf extending out from the internal face of a side surface that may provide a surface for the post 130 to rest on. According to some embodiments, when the one or more posts 130 are inserted into an open first end 212 of the one or more internal grooves 208 of the mounting enclosure 200, the movement of the insert panel 100 may be restricted to the path of the internal grooves 208. Accordingly, the insert panel 100 may then be guided into the proper insertion position by the one or more internal grooves 208 as the insert panel is moved forwards towards a second end 214 of the one or more internal grooves 208, proximate the front of the surface of the mounting enclosure 200. In some embodiments, the second end 214 of the one or more internal grooves 208 may include a ridge that prevents the posts 130 from moving any further in the direction towards the front surface of the mounting enclosure 200. In some embodiments, the second end of the one or more internal grooves may positioned in a location that corresponds to a positioning of the insert panel 100 that may allow the insert panel 100 to be rotated to substantially fit into the aperture 202 of the mounting enclosure 200.

As shown in FIGS. 1A-2D, according to some embodiments, the insert panel 100 may include a mounting aperture 122 for mounting the burner apparatus 300. In some embodiments, the burner apparatus 300 may include a nozzle 302 that may be inserted through the mounting aperture 122 of the insert panel 100. According to some embodiments, the mounting aperture 122 and nozzle 302 may be sized such that the nozzle may substantially occupy the aperture 122 when inserted into the insert panel 100. For example, they may be sized such that there is a seal between the edge of the nozzle 302 and the edge of the mounting aperture 122 when the nozzle 302 is positioned within the mounting aperture 122. The seal may prevent heat from leaking into the interior of the mounting enclosure 200 when the burner 300 is in use in the furnace. The nozzle 302 may be made out of water-cooled, or gas-cooled copper, which may be resistant to the high internal temperatures of the furnace.

In some embodiments, the insert panel 100 may also include an inlet opening 124a, outlet opening 124b, and a delivery aperture 126 that may receive or connect to other portions of the burner apparatus 300 or other devices or pipes. For example, the inlet opening 124a may be configured to receive or be coupled with a hose or a pipe for pumping a fluid into the insert panel 100 Likewise, the outlet opening 124b may be configured to receive or be coupled with a hose or a pipe for pumping the fluid out of the insert panel 100. In some embodiments, the delivery aperture 126 may be configured to receive a nozzle, pipe, or other structure for delivering one or more materials, such as a gas, a liquid, a chemical, or a reactive agent in the form of particles, into the furnace for assisting in the melting, refining, and processing of the materials in the furnace.

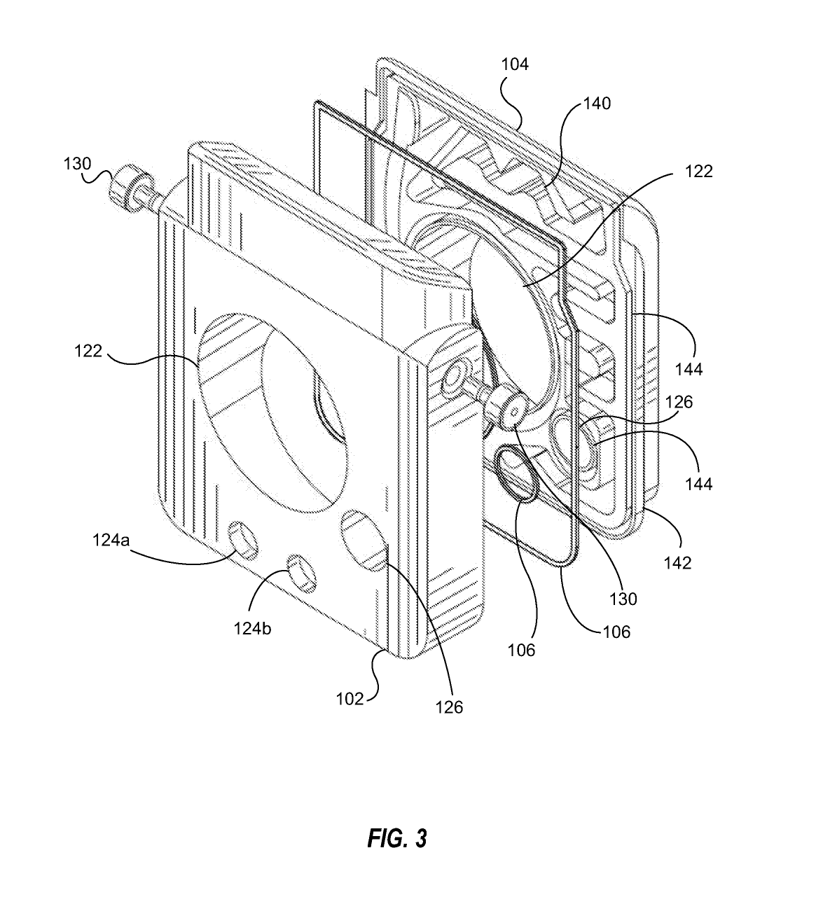

FIG. 3 shows an exploded view of an embodiment of a removable insert panel 100. Because the insert panel 100 may face the most intense heat flux from the molten steel and slag from the electric arc, it may be fluid cooled and fabricated from material with very high thermal conductivity. In some embodiments, the insert panel may be made of oxygen-free copper. In some embodiments the insert panel 100 may be include a host plate 102 aligned and joined with a front plate 104. In some embodiments, the host plate 102 and front plate 104 may be joined such that a delivery aperture 126 of the host plate 102 and front plate 104 align to form one continuous mounting aperture 122 and/or one continuous delivery aperture 126.

According to some embodiments, the front plate 104 may have a front surface that faces the interior of the furnace. In some embodiments, the front plate 104 may include a lip 142 that extends below a first bottom surface of the front plate 104, as shown in FIG. 3. The lip 142 may be configured to engage with a lip 204 of the mounting enclosure 200 to prevent the bottom portion of the insert panel 100 from rotating beyond the sloped lower surface of the front surface of the mounting enclosure 200. The front plate 104 may be made out of high conductivity copper that may transfer the high level of heat through the cooling fluid supplied between front plate 104 and the host plate 102. In some embodiments, the front plate 104 may wear out over time and require replacement because it may be directly exposed to the interior heat of the furnace and splashes of hot metal and slag. One advantage of constructing a removable insert panel 100 from a host plate 102 and a front plate 104 is that if the front plate 104 becomes worn out but the host plate 102 is still in good condition, a user may simply remove the insert panel 100 and replace the front plate 104 while retaining the host plate 102, which may save money on maintenance and repair costs. According to some embodiments, the host plate 102 and/or the front plate 104 may be manufactured through a machining process. In some embodiments, the host plate 102 and/or the front plate 104 may be fabricated through a casting or molding process.

According to some embodiments, the host plate 102 and the front plate 104 may be joined with a sealing element between them. For example, in some embodiments, an assembled insert panel 100 may include one or more O-rings 106 between the front face of the host plate 102 and the rear face of the front plate 104. The front face of the host place 102 and the rear face of the front plate 104 may include one or more complementary grooves 144, such that the grooves of the host plate 102 align with the grooves of the front plate 104 when assembled. In some embodiments, an assembled insert panel 100 may include one or more O-rings 106 that are positioned within the complementary grooves 144 in order to provide a seal between the host plate 102 and the front plate 104. Assembling the insert panel 100 with a sealing element such as an O-ring 106 may be advantageous compared to conventional panels that are simply welded together because the welding may crack during use in the furnace due to variable heat flux that may occur during welding the panel together. The inclusion of a sealing element, such as an O-ring 106 may eliminate partial leaks in the welding. According to some embodiments, an O-ring 106 may be configured to withstand temperatures of 300-500 degrees Fahrenheit.

Furthermore, in some embodiments the host plate 102 may include a plurality of apertures for receiving a plurality of securing devices, such as, for example, a plurality of bolts. In some embodiments, the rear surface of the front plate 104 may include a plurality of recesses positioned to align with the plurality of apertures of the host plate 102 and further configured to receive the plurality of securing devices. For example, in some embodiments, the host plate 102 may be removably secured to the front plate by a plurality of bolts that are positioned in the plurality of apertures of the host plate 102 and terminate in the plurality of recesses of the front plate 104. In some embodiments, the plurality of securing devices may be coupled with a plurality of washers that may withstand pressures of up to 1400 psi.

As shown in FIG. 3, in some embodiments, the rear face of the front plate 104 may include one or more channels 140 or cooling circuits that may facilitate the flow of a cooling fluid throughout the insert panel. In some embodiments, a channel 140 may be a recess in the surface of the front plate 104 that has a first end and a second end. According to some embodiments, the first end of a channel 140 may align with an inlet opening 124a of the host plate 102 and the second end of the channel 140 may align with an outlet opening 124b of the host plate 102. Accordingly, in some embodiments, a fluid, such as cooling water or some other cooling fluid, may be pumped into the inlet opening 124a of the host plate 102, transported throughout an internal channel 140 of the insert panel 100, and may exit the insert panel 100 through the outlet opening 124b. In this way, one or more cooling circuits may exist within the insert panel 100 that allow a cooling fluid to continuously remove heat from the insert panel 100 and/or the adjacent mounting enclosure 200 and burner assembly 300. In some embodiments, a fluid may be pumped through the insert panel 100 at a rate of about 2-70 GPM.

FIGS. 4A-4C show an example embodiment of the removal of a removable insert panel 100. FIG. 4A shows an insert panel 100 that has been fully inserted into the mounting enclosure 200 and is ready to receive a burner apparatus 300. As can be seen, the posts 130 of the insert panel 100 may be positioned within respective internal grooves (or channels) 208 of the mounting enclosure 200. Furthermore, when the insert panel 100 is positioned to substantially occupy the aperture 202 of the mounting enclosure 200, the lip 142 of the front plate 104 may engage the lip 204 of the mounting enclosure and a top portion of the rear surface of the insert panel 100 may engage a top surface of the mounting enclosure 200 to secure the insert panel 100 in place, as shown in FIG. 2D. According to some embodiments, an internal groove 208 may include a first end 212 that may be accessed from the rear of the mounting enclosure 200, and a second end 214 that may terminate towards the front surface of the mounting enclosure 200. The grooves 208 may be configured to guide an inserted post 130 from the first end 212 of the groove 208 to the second end 214 of the groove 208. According to some embodiments, if a user wants to remove the insert panel 100, the user may disconnect any pipes and hoses that may be connected to the insert panel 100, lift up a lower portion of the removable insert panel 100, disengaging the lip 142 of the front plate from the lip 204 of the mounting enclosure 200 and rotating the body of the insert panel 100 upwards, as shown in FIG. 4B. According to some embodiments, when the removable insert panel 100 is positioned with the posts 130 at the second end 214 of the grooves 208, the removable insert panel 100 may rotate about a common axis of rotation provided by a first post 130 and a second post 130. Once in a rotated position, the insert panel 100 can be pulled towards the rear open end of the mounting enclosure 200, as shown in FIG. 4C. As the insert panel 100 is pulled backwards, the posts 130 may be guided along the internal grooves 208 of the mounting enclosure 200. According to some embodiments, when the posts 130 exit the internal grooves 208 of the mounting enclosure 200 at the first end 212 of the internal grooves 208, the insert panel 100 may be completely free to be removed and replaced.

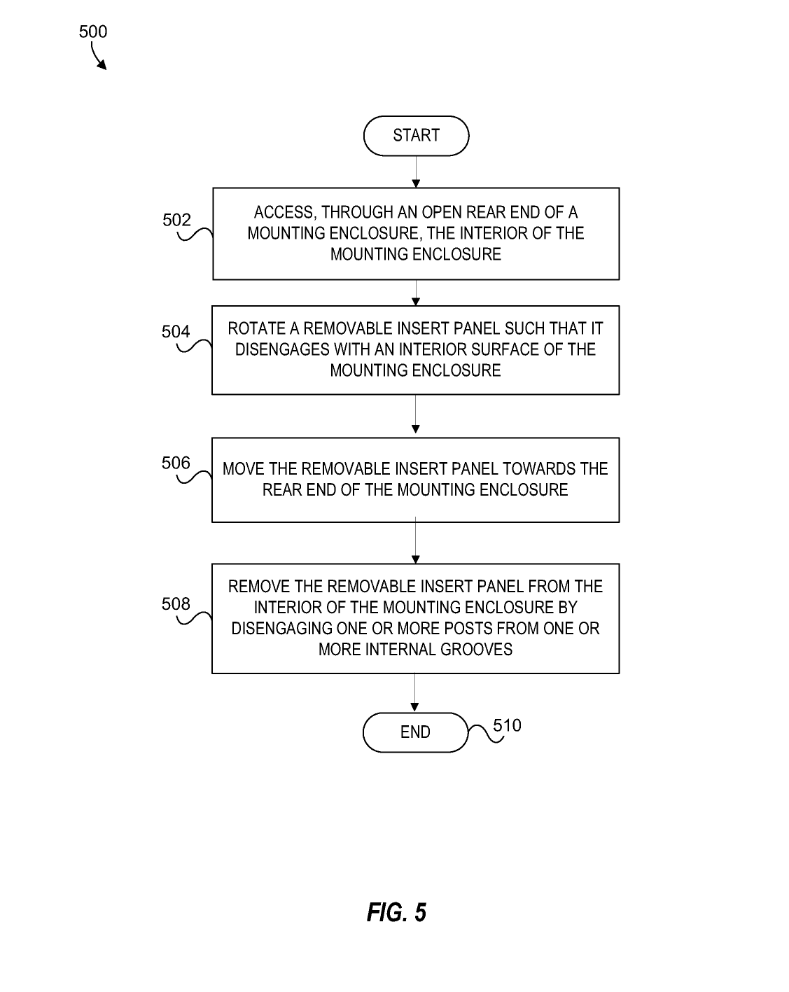

FIG. 5 is a flow diagram of a method 500 according to an example embodiment of the disclosed technology. As shown, the method 500 begins with a user accessing 502, through a rear open face of a mounting enclosure that is positioned for use in an electric arc furnace, the interior of the mounting enclosure. For example, a user my reach their hands into the cavity of the mounting enclosure while positioned externally to the furnace. The method 500 further includes rotating 504 of a removable insert panel such that it disengages with an interior surface of the mounting enclosure. According to some embodiments, the removable insert panel may be positioned to substantially occupy an aperture of the mounting enclosure and a user may rotate the removable insert panel such that the insert panel only partially occupies the aperture of the mounting enclosure. In some embodiments, rotating the removable insert panel may involve disengaging a lip of the removable insert panel from a lip of the mounting enclosure. The method 500 may further include moving 506 the removable insert panel towards the rear of the mounting enclosure, wherein the path of the movement of the removable insert panel is guided by one or more posts of the removable insert panel that are positioned within one or more internal grooves of the mounting enclosure. The method 500 may further include removing 508, the removable insert panel from the interior of the mounting enclosure upon the one or more posts of the removable insert panel arriving at the end of the one or more internal grooves by disengaging the one or more posts from the one or more internal grooves of the mounting enclosure. After removing 508 the removable insert panel, the method 500 ends 510.

Certain implementations of the disclosed technology are described above with reference to a flow diagram a method of an example embodiment of the disclosed technology. It will be understood that one or more blocks of the flow diagram may be performed by a user of the system. Some blocks of the flow diagrams may not necessarily need to be performed in the order presented, may be repeated, or may not necessarily need to be performed at all, according to some embodiments of the disclosed technology.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A mounting enclosure system comprising:
a mounting enclosure having:
an aperture for receiving a removable insert panel;
a first channel positioned on a first internal surface of the mounting enclosure, the first channel configured to receive a first pole member of the removable insert panel; and
a second channel positioned on a second internal surface of the mounting enclosure, the second channel configured to receive a second pole member of the removable insert panel; and
a removable insert panel having:
a first pole member extending outwards from a first surface of the removable insert panel; and
a second pole member extending outwards from a second surface of the removable insert panel.

2. The mounting enclosure system of claim 1, wherein the removable panel is configured to substantially occupy the aperture of the front surface of the mounting enclosure.

3. The mounting enclosure system of claim 1, wherein the first pole member of the removable insert panel comprises a first roller and the second pole member of the removable insert panel comprises a second roller.

4. The mounting enclosure system of claim 3, wherein an axis of rotation is formed by the first roller and the second roller.

5. The mounting enclosure system of claim 3, wherein a first end of the first channel of the first side surface is configured to receive the first roller and a first end of the second channel of the second side surface is configured to receive the second roller.

6. The mounting enclosure system of claim 5, wherein the first channel of the first side surface and the second channel of the second side surface are configured to guide the removable insert panel from the first end of the first channel and the first end of the second channel to a second end of the first channel and a second end of the second channel.

7. The mounting enclosure system of claim 6, wherein when positioned at the second ends of the first and second channels, the removable insert panel is configured to rotate around the axis of rotation formed by the first roller and the second roller.

8. The mounting enclosure system of claim 7, wherein the removable insert panel is configured to rotate into the aperture of the front surface of the mounting enclosure, such that the removable insert panel substantially occupies the aperture of the front surface of the mounting enclosure.

9. The mounting enclosure system of claim 8, wherein a lip of the removable insert panel is configured to engage a lip of the mounting aperture when the removable insert panel is inserted into the aperture of the front surface of the mounting enclosure.

10. A removable insert panel comprising:
a front face;
a rear end;
a first side surface;
a second side surface;
a mounting aperture disposed between the front face and the rear end and configured to receive a burner apparatus; and
a pair of pole members extending out of the first and second side surfaces, respectively.

11. The removable insert panel of claim 10, further comprising:
an inlet aperture disposed on the rear face, the inlet aperture configured to receive an inflow of a fluid;
an outlet aperture disposed on the rear face, the outlet aperture configured to expel an outflow of the fluid;
a channel connected to the inlet aperture and outlet aperture, the channel disposed internally to the removable insert panel and configured to provide a cooling effect by circulating the fluid throughout the removable insert panel.

12. The removable insert panel of claim 10, wherein the removable insert panel comprises a host plate joined to a front plate.

13. The removable insert panel of claim 12, wherein the host plate includes the pair of pole members.

14. The removable insert panel of claim 12, further comprising a sealing element positioned between the host plate and the front plate.

15. The removable insert panel of claim 14, wherein the sealing element substantially occupies a space between a pair of complementary grooves in the host plate and the front plate when the insert panel is assembled.

16. The removable insert panel of claim 15, wherein the sealing element is an O-ring.

17. A mounting enclosure comprising a hollow cavity defined by:
a top surface;
a bottom surface;
a first side surface, an internal surface of the first side surface including a first channel configured to receive a first pole member of a removable insert panel;
a second side surface, an internal surface of the second side surface including a second channel configured to receive a second pole member of a removable insert panel;
a front surface comprising:
a sloped upper surface; and
a sloped lower surface, the sloped lower surface including an aperture configured to receive a removable insert panel.

18. The mounting enclosure of claim 17, wherein the sloped lower surface includes a lip extending upwards away from the bottom surface, the lip configured to receive a complementary lip of the removable insert panel.

19. The mounting enclosure of claim 17, wherein the first channel comprises a first recess in the first side surface and the second channel comprises a second recess in the second side surface.

20. The mounting enclosure of claim 19, wherein each of the first and second recesses are configured to receive a roller of the removable insert panel.

21. The mounting enclosure of claim 20, wherein each of the first and second recesses are configured to guide an insert panel from the rear end of the mounting enclosure to the front end of the mounting enclosure to a position where the removable insert panel may rotate into the aperture configured to receive the removable insert panel.

22. A method comprising:
accessing, through an open rear end of a mounting enclosure, the interior of the mounting enclosure that is positioned for use with a furnace,
rotating a removable insert panel such that it disengages with an interior surface of the mounting enclosure;
moving the removable insert panel towards the rear of the mounting enclosure, wherein the path of movement of the removable insert panel is guided by one or more posts of the removable insert panel that are positioned within one or more internal grooves of the mounting enclosure;
removing the removable insert panel from the interior of the mounting enclosure upon the one or more posts of the removable insert panel arriving at the end of the one or more internal grooves by disengaging the one or more posts from the one or more internal grooves of the mounting enclosure.
